(19) United States
(12) Patent Application Publication
(10) Pub. No.: US 2026/0035179 A1
(43) Pub. Date: Feb. 5, 2026

(54) METHOD AND SYSTEM FOR DETERMINING DEPTH OR OBSTRUCTION OF A GRIPPING ASSEMBLY

(71) Applicant: Ocado Innovation Limited, Hatfield (GB)

(72) Inventors: Clifton HOYLE, Hatfield (GB); Daniel CLARK, Harpenden (GB); David BURCH, Reading (GB); Sorin MIHAI, Stevenage (GB); Matthew WHELAN, Stockholm (SE); Vincent LI, St Albans (GB)

(21) Appl. No.: 19/299,195

(22) Filed: Aug. 13, 2025

Related U.S. Application Data
(63) Continuation of application No. PCT/EP2024/053261, filed on Feb. 8, 2024.

(51) Int. Cl. B65G 1/04

(52) U.S. Cl. CPC B65G 1/0464; B65G 2203/0283

(57) ABSTRACT

A method and system for determining depth or obstruction of a container-gripping assembly is disclosed. The method and system use a sensor to determine the depth or obstruction of a container-gripping assembly.

### CROSS-REFERENCE TO RELATED APPLICATIONS

This Application is a continuation of PCT International Patent Application No. PCT/EP2024/053261, filed on Feb. 8, 2024, which claims priority to UK Patent Application No. GB2302075.3, filed on Feb. 14, 2023, and UK Patent Application No. GB2302083.7, filed on Feb. 14, 2023, the entire contents of each of which are hereby incorporated by reference.

### TECHNICAL FIELD

The present invention relates to a method and system for determining depth of a gripping assembly, such as one used in a load-handling device.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load-handling devices operative on rails or tracks located on the top of the grid storage structure. The load-handling devices are further described in WO2015/019055A1.

A load-handling device comprises a container-lifting assembly that uses a raising and lowering assembly to raise and/or lower a container-gripping assembly. The raising and lowering assembly controls the raising and lowering of the container-gripping assembly according to the vertical position of the container-gripping assembly. For example as the container-gripping assembly is lowered and approaches a container, the container-gripping assembly decelerates. It is important to determine accurately the vertical position of the container-gripping assembly to control the deceleration. The same is true as the container-gripping assembly is raised and approaches the load-handling device. It is also important to determine whether the container-gripping assembly has been obstructed during raising and lowering. It is against this background that the present invention has been devised.

### SUMMARY

In a first aspect, there is a lifting assembly for raising and/or lowering a container from and/or to a stack of containers in a grid storage structure, the lifting assembly comprising: a gripping assembly configured to grip a load; a raising and lowering assembly configured to raise and lower the gripping assembly, the raising and lowering assembly comprising: at least one tether connected to the gripping assembly; a motor to wind and/or unwind the or each tether to raise and/or lower the gripping assembly, wherein the lifting assembly further comprises: a sensor configured to detect movement of the gripping assembly, wherein the sensor comprises an input that is engaged by movement of the gripping assembly; and a controller configured to determine a vertical position of the gripping assembly using an output of the sensor. This means the extent to which the gripping assembly has been raised and/or lowered can be monitored.

The raising and lowering assembly may comprise an electrical cable connected to the gripping assembly, wherein the electrical cable is configured to wind and/or unwind as the gripping assembly is raised and/or lowered, and wherein the sensor is configured to detect the extent to which the electrical cable has wound and/or unwound. This means a direct extension of the electrical cable can be used to accurately determine the vertical position. In one implementation, the lifting assembly further comprises an electrical cable spool on which the electrical cable winds and/or unwinds, wherein the sensor comprises a rotary encoder configured to engage with the electrical cable spool to detect the extent to which the electrical cable spool has rotated as the electrical cable winds and/or unwinds.

The electrical cable may have a higher modulus of elasticity than the or each tether. This means the effects of stretch are reduced so accuracy is maximised.

The lifting assembly may further comprise a tether spool for the or each tether on which the or each tether winds and/or unwinds, wherein the electrical cable spool and the or each tether spool are mounted on a shaft such that the electrical cable spool can rotate relative to the or each tether spool. In one implementation, the lifting assembly of claims, further comprises a biasing assembly configured to oppose the unwinding of the electrical cable spool or the winding of the electrical cable spool such that the electrical cable is taut between the raising and lowering assembly and the gripping assembly. This means the electrical cable remains taut so accuracy is maximised.

The electrical cable may communicate electrical signals to the gripping assembly. The electrical cable may comprise flat fixed flexible cable (FFC) or ribbon cable.

The sensor may comprise a motor encoder of the motor, wherein the motor encoder is configured to detect the extent to which the or each tether has wound and/or unwound. This means a direct extension of the or each tether can be used to accurately determine the vertical position. In one implementation, the lifting assembly may further comprise a tether spool for the or each tether on which the or each tether winds and/or unwinds, wherein the motor encoder detects the extent to which the or each tether spool has rotated as the or each tether winds and/or unwinds. The sensor may comprise: a rotary encoder configured to detect the extent to which the or each tether has wound and/or unwound; or a rotary encoder for the or each tether spool, wherein the or each rotary encoder is configured to engage with the or each spool to detect the extent to which the or each spool has rotated as the or each respective tether winds and/or unwinds.

The sensor may comprise a rotary encoder for the or each tether, wherein the rotary encoder is configured to contact a respective tether such that the winding and/or unwinding of the or each respective tether rotates an input of the rotary encoder. This means a direct extension of a tether can be used to accurately determine the vertical position.

The raising and lowering assembly may comprise an electrical cable connected to the gripping assembly, wherein the electrical cable is configured to wind and/or unwind as the gripping mechanism is raised and/or lowered, and the sensor may comprise a rotary encoder, wherein the rotary encoder is configured to engage with the electrical cable such that the winding and/or unwinding of the or each tether rotates a shaft of the rotary encoder. This means a direct extension of the electrical cable can be used to accurately determine the vertical position.

The lifting assembly may further comprise a biasing assembly configured to bias the or each rotary encoder into contact with the or each respective tether or electrical cable. This ensures the rotary encoder maintains contact with the each respective tether or electrical cable.

The raising and lowering assembly may comprise an electrical wire connected to the gripping device, wherein the electrical wire is configured to wind and/or unwind as the gripping assembly is raised and/or lowered, an electrical wire spool on which the electrical wire winds and/or unwinds, wherein the wire is wound on the electrical wire spool such that the wire on the electrical wire spool is short-circuited, and wherein the sensor may be configured to measure the electrical resistance of the electrical wire as the electrical wire winds and/or unwinds. This means a direct extension of the electrical wire can be used to accurately determine the vertical position.

The lifting assembly may further comprise a biasing assembly configured to oppose the unwinding of the electrical wire spool or the winding of the electrical wire spool such that the electrical wire is taut between the raising and lowering assembly and the gripping assembly. This means the electrical wire remains taut so accuracy is maximised.

The sensor may comprise a time of flight (ToF) sensor. This means a direct movement of the gripping assembly can be used to accurately determine the vertical position.

The sensor may comprise a light source and a light detector, wherein the light source is configured to transmit an optical signal onto a surface that moves as the gripping assembly is raised and/or lowered, and the light detector may be configured to detect a reflection of the optical signal from the surface to detect movement of the surface. This means a direct movement of the gripping assembly can be used to accurately determine the vertical position. In one implementation, the raising and lowering assembly may comprise an electrical cable connected to the gripping assembly, wherein the electrical cable is configured to wind and/or unwind as the gripping mechanism is raised and/or lowered. The raising and lowering assembly may comprise a wheel that is in contact with a tether spool on which the or each respective tether winds and/or unwinds, or an electrical cable spool on which the electrical cable winds and/or unwinds, wherein the wheel comprises the surface. The or each tether spool or the electrical cable spool may comprise the surface.

The controller may be configured to use the determined vertical position to control/adjust the raising and or lowering of the gripping-assembly. This means the gripping assembly can be accurately controlled using feedback.

In another aspect, there is a load-handling device for lifting and moving storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device comprising: a body or skeleton mounted on a first set of wheels being arranged to engage with the first set of parallel tracks and a second set of wheels being arranged to engage with the second set of parallel tracks; and a container-lifting assembly comprising the lifting assembly of any preceding aspect, wherein the gripping assembly comprises a container-gripping assembly configured to grip a container.

In another aspect, there is a method for determining a vertical position for the gripping assembly of the lifting assembly of any preceding aspect, wherein the method comprises: using the motor to raise and/or lower the gripping assembly; using the controller to determine a vertical position of the gripping assembly using an output of the sensor.

In another aspect, there is a computer program comprising instructions which, when the program is executed by a computer, cause the computer to carry out the method of the previous aspect.

In an aspect, there is a lifting assembly for raising and/or lowering a container from and/or to a stack of containers in a grid storage structure, the lifting assembly comprising: a gripping assembly configured to grip a load; a raising and lowering assembly configured to raise and lower the gripping assembly, the raising and lowering assembly comprising: at least one tether connected to the gripping assembly; a motor configured to wind and/or unwind the or each tether about at least one shaft to raise and/or lower the gripping assembly, wherein the lifting assembly further comprises: a sensor configured to detect movement of the gripping assembly; and a controller configured to determine an obstruction of the gripping assembly if a current output of the sensor does not correlate to the winding and/or unwinding of the or each tether about the or each shaft to raise and/or lower the gripping assembly. This means a malfunction or incorrect operation during raising and/or lowering of the gripping assembly can be detected.

The lifting assembly of claim I may further comprise a second sensor, wherein the second sensor directly detects rotation of the at least one shaft. This means the winding and/or unwinding of the or each tether can be detected.

In one implementation, the second sensor may comprise a motor encoder of the motor, wherein the controller may be configured to determine the obstruction of the gripping assembly if a current output of the sensor does not correlate to a current output of the motor encoder. The controller may be configured to determine the obstruction of the grid assembly if a current output of the sensor does not correlate to a current output of the motor encoder by a threshold. This means a tolerance is allowed to account for stretching of the or each tether.

In another implementation, the lifting assembly may further comprise a tether spool for the or each tether on which the or each tether winds and/or unwinds, wherein the second sensor may comprise a tether rotary encoder for the or each tether spool, wherein the or each tether rotary encoder may be configured to engage with the or each spool to detect the extent to which the or each spool has rotated as the or each respective tether winds and/or unwinds, and wherein the controller is configured to determine the obstruction of the gripping assembly if a current output of the sensor does not correlate to a current output of the or each tether rotary encoder. The controller may be configured to determine the obstruction of the gripping assembly if a current output of the sensor does not correlate to a current output of the tether rotary encoder by a threshold. This means a tolerance is allowed to account for stretching of the or each tether.

In another implementation, the raising and lowering assembly may comprise an electrical cable connected to the gripping assembly, wherein the electrical cable is configured to wind and/or unwind as the gripping assembly is raised and/or lowered, an electrical cable spool on which the electrical cable winds and/or unwinds, wherein the electrical cable spool is fixedly mounted on the or each shaft, wherein the second sensor comprises an electrical cable rotary encoder for the electrical cable spool, wherein the or each electrical cable rotary encoder is configured to engage with the electrical cable spool to detect the extent to which the electrical cable spool has rotated as the electrical cable winds and/or unwinds, and wherein the controller is configured to determine the obstruction of the gripping assembly if a current output of the sensor does not correlate to a current output of the electrical cable rotary encoder.

In another implementation, the lifting assembly may further comprise a tether spool for the or each tether on which the or each tether winds and/or unwinds, wherein the second sensor comprises a tether spool sensor comprising a light source and a light detector, wherein the light source is configured to transmit an optical signal onto a surface that moves as the gripping assembly is raised and/or lowered, wherein the light detector is configured to detect a reflection of the optical signal from the surface to detect movement of the surface, and wherein the controller is configured to determine the obstruction of the gripping assembly if a current output of the sensor does not correlate to a current output of the tether spool sensor. The raising and lowering assembly may comprise a wheel that is in contact with a tether spool on which the or each respective tether winds and/or unwinds, wherein the wheel comprises the surface. The or each tether spool may comprise the surface.

In another implementation, the raising and lowering assembly may comprise an electrical cable connected to the gripping assembly, wherein the electrical cable is configured to wind and/or unwind as the gripping assembly is raised and/or lowered, an electrical cable spool on which the electrical cable winds and/or unwinds, wherein the second sensor comprises an electrical cable spool sensor comprising a light source and a light detector, wherein the light source is configured to transmit an optical signal onto a surface that moves as the gripping assembly is raised and/or lowered, the light detector is configured to detect a reflection of the optical signal from the surface to detect movement of the surface, and wherein the controller is configured to determine the obstruction of the gripping assembly if a current output of the sensor does not correlate to a current output of the electrical cable spool sensor. The raising and lowering assembly may comprise a wheel that is in contact with an electrical cable spool on which the electrical cable winds and/or unwinds, wherein the wheel comprises the surface; The electrical cable spool may comprise the surface.

The sensor may comprise an input that is engaged by movement of the gripping assembly, and wherein the controller may be configured to receive a motion profile that controls the raising and/or lowering of the gripper-assembly, determine a vertical position of the gripping assembly using the output of the sensor, and determine the obstruction of the gripping assembly if the vertical position of the gripping assembly at a current time does not correlate to a corresponding vertical position derived from the motion profile by a threshold. This means a single sensor can be used to determine obstruction.

The raising and lowering assembly may comprise an electrical cable connected to the gripping assembly, wherein the electrical cable may be configured to wind and/or unwind as the gripping assembly is raised and/or lowered, wherein the sensor may be configured to detect the extent to which the electrical cable has wound and/or unwound, and a biasing assembly configured to oppose the unwinding of the electrical cable spool or the winding of the electrical cable spool such that the electrical cable is taut between the raising and lowering assembly and the gripping assembly. The lifting assembly may further comprise an electrical cable spool on which the electrical cable winds and/or unwinds, wherein the sensor may comprise a rotary encoder configured to engage with the electrical cable spool to detect the extent to which the electrical cable spool has rotated as the electrical cable winds and/or unwinds, wherein the electrical cable spool may be configured to rotate relative to the or each shaft. This means the electrical cable will return to its biased state upon movement of the gripping assembly being obstructed, which will be detected by the rotary encoder. In one implementation, the electrical cable may have a higher modulus of elasticity than the or each tether. In another implementation, the electrical cable may communicate electrical signals to the gripping assembly. In another implementation, the electrical cable may comprise FFC or ribbon cable.

The sensor may comprise a rotary encoder for the or each tether, wherein the rotary encoder is configured to contact a respective tether such that the winding and/or unwinding of the or each respective tether rotates an input of the rotary encoder. The raising and lowering assembly may comprise an electrical cable connected to the gripping assembly, wherein the electrical cable is configured to wind and/or unwind as the gripping mechanism is raised and/or lowered, wherein the electrical cable optionally comprises FFC or ribbon cable, and wherein the sensor may comprise a rotary encoder, wherein the rotary encoder may be configured to engage with the electrical cable such that the winding and/or unwinding of the or each tether rotates a shaft of the rotary encoder. This means loss of contact between the rotary encoder and the or each tether or the electrical cable, due to slack for example, will be detected by rotary encoder. A biasing assembly may be configured to bias the or each rotary encoder into contact with the or each respective tether or electrical cable. This ensures contact between the rotary encoder and the or each respective tether or electrical cable.

The raising and lowering assembly may comprise an electrical cable connected to the gripping assembly, wherein the electrical cable is configured to wind and/or unwind as the gripping mechanism is raised and/or lowered, an electrical cable spool on which the electrical cable winds and/or unwinds, wherein the electrical cable spool is configured to rotate relative to the or each shaft, a biasing assembly configured to oppose the unwinding of the electrical cable spool or the winding of the electrical cable spool such that the electrical cable is taut between the raising and lowering assembly and the gripping assembly, wherein the sensor comprises an electrical cable spool sensor comprising a light source and a light detector, wherein the light source is configured to transmit an optical signal onto a surface that moves as the gripping assembly is raised and/or lowered, and the light detector is configured to detect a reflection of the optical signal from the surface to detect movement of the surface, wherein the raising and lowering assembly may comprise a wheel that is in contact with the electrical cable spool on which the or each respective tether winds and/or unwinds, wherein the wheel comprises the surface, or wherein the electrical cable spool may comprise the surface. This means the electrical cable will return to its biased state upon movement of the gripping assembly being obstructed, which will be detected by the electrical cable spool sensor.

The raising and lowering assembly may comprise an electrical wire connected to the gripping device, wherein the electrical wire is configured to wind and/or unwind as the gripping assembly is raised and/or lowered, an electrical wire spool on which the electrical wire winds and/or unwinds, wherein the wire is wound on the electrical wire spool such that the wire on the electrical wire spool is short-circuited, wherein the electrical wire spool is configured to rotate relative to the or each shaft, a biasing assembly configured to oppose the unwinding of the electrical wire spool or the winding of the electrical wire spool such that the electrical wire is taut between the raising and lowering assembly and the gripping assembly, and wherein the sensor is configured to measure the electrical resistance of the electrical wire as the electrical wire winds and/or unwinds. This means the electrical wire will return to its biased state upon movement of the gripping assembly being obstructed, which will be detected by the sensor.

The sensor may comprise a time of flight (ToF) sensor. This will detect movement of the gripping assembly being obstructed.

The controller may be configured to stop the motor upon determining an obstruction of the gripping-assembly. This means the unspooling of the or each otherwise slack tether is prevented.

In another aspect, there is a load-handling device for lifting and moving storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device comprising: a body or skeleton mounted on a first set of wheels being arranged to engage with the first set of parallel tracks and a second set of wheels being arranged to engage with the second set of parallel tracks; and a container-lifting assembly comprising the lifting assembly of any preceding aspect, wherein the gripping assembly comprises a container-gripping assembly configured to releasably grip a container.

In another aspect, there is a method for determining an obstruction for the gripping assembly of the lifting assembly of any preceding aspect, wherein the method comprises: using the motor to raise and/or lower the gripping assembly; and using the controller to determine an obstruction of the gripping assembly if a current output of the sensor does not correlate to the winding and/or unwinding of the or each tether about the or each shaft to raise and/or lower the gripping assembly.

In another aspect, there is a computer program comprising instructions which, when the program is executed by a computer, cause the computer to carry out the method of the preceding aspect.

### DESCRIPTION OF THE DRAWINGS

The present invention is described with reference to one or more exemplary embodiments as depicted in the accompanying drawings, wherein:

FIG. 1 shows a storage structure and containers;

FIG. 2 shows track on top of the storage structure illustrated in FIG. 1;

FIG. 3 shows load-handling devices on top of the storage structure illustrated in FIG. 1;

FIG. 4 shows a single load-handling device with container-lifting means in a lowered configuration;

FIG. 5A shows a cutaway view of a single load-handling device with container-lifting means in a raised configuration, and FIG. 5B shows a cutaway view of a single load-handling device with container-lifting means in a lowered configuration;

FIG. 7 shows a method according to the invention;

FIG. 8 shows a system according to the invention;

FIG. 9 shows a system according to the invention;

FIG. 10 shows a system according to the invention;

FIG. 11A shows a first view of a sensor according to the invention, and FIG. 11B shows a second view of a sensor according to the invention;

FIG. 12 shows another sensor according to the invention;

FIG. 13 shows another sensor according to the invention;

FIG. 14 shows another sensor according to the invention;

FIG. 15 shows another sensor according to the invention;

FIG. 16 shows a system according to the invention; and

FIG. 17 shows a method according to the invention.

### DETAILED DESCRIPTION

Online retail businesses selling multiple product lines, such as online grocers and supermarkets, require systems that can store tens or hundreds of thousands of different product lines. The use of single-product stacks in such cases can be impractical since a vast floor area would be required to accommodate all of the stacks required. Furthermore, it can be desirable to store small quantities of some items, such as perishables or infrequently ordered goods, making single-product stacks an inefficient solution.

International patent application WO 98/049075A (Autostore), the contents of which are incorporated herein by reference, describes a system in which multi-product stacks of containers are arranged within a frame structure.

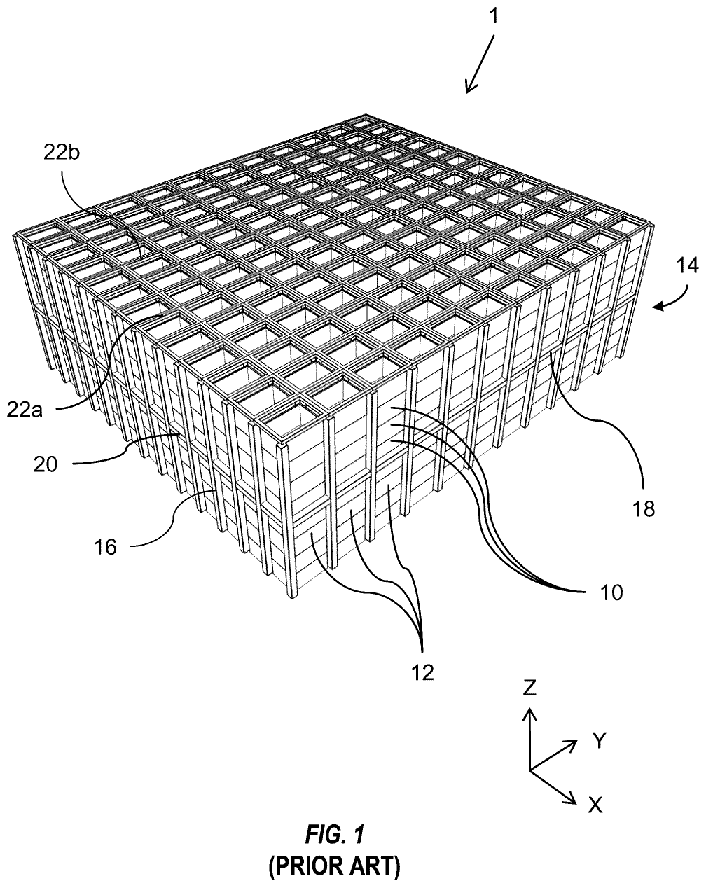

PCT Publication No. WO2015/185628A (Ocado) describes a further known storage and fulfilment system in which stacks of containers are arranged within a grid framework structure (or a grid storage structure). The containers are accessed by one or more load-handling devices, otherwise known as “bots”, operative on tracks located on the top of the grid framework structure. A system of this type is illustrated schematically in FIGS. 1-3 of the accompanying drawings.

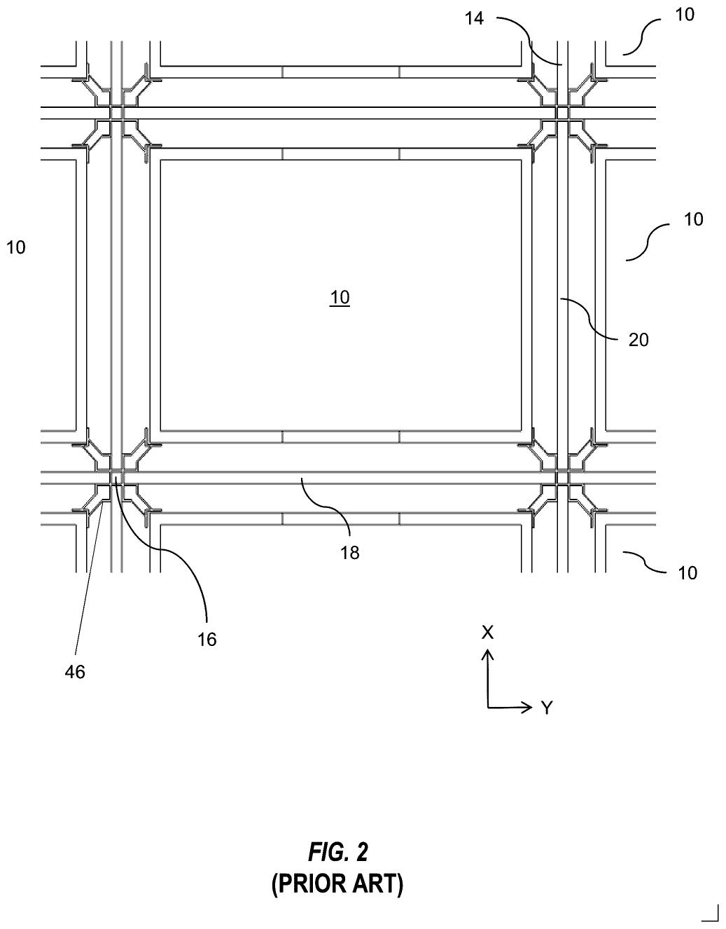

As shown in FIG. 1 and FIG. 2, containers or bins 10 are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 1 is a schematic perspective view of the grid framework structure 14, and FIG. 2 is a schematic top-down view showing a stack 12 of bins 10 arranged within the grid framework structure 14. Each bin 10 typically holds a plurality of product items (not shown). The product items within a bin 10 may be identical or different product types depending on the application.

The grid framework structure 14 comprises a plurality of vertical members 16 that support horizontal members 18, 20. A first set of parallel horizontal grid members 18 is arranged perpendicularly to a second set of parallel horizontal members 20 in a grid pattern to form a horizontal grid structure 15 supported by the vertical members 16. The vertical members 16 and horizontal members 18, 20 are typically manufactured from metal. The bins 10 are stacked between the vertical members 16 and horizontal members 18, 20 of the grid framework structure 14, so that the grid framework structure 14 guards against horizontal movement of the stacks 12 of bins 10 and guides the vertical movement of the bins 10. FIG. 2 shows a top view 46 of the vertical members 16 of FIG. 1.

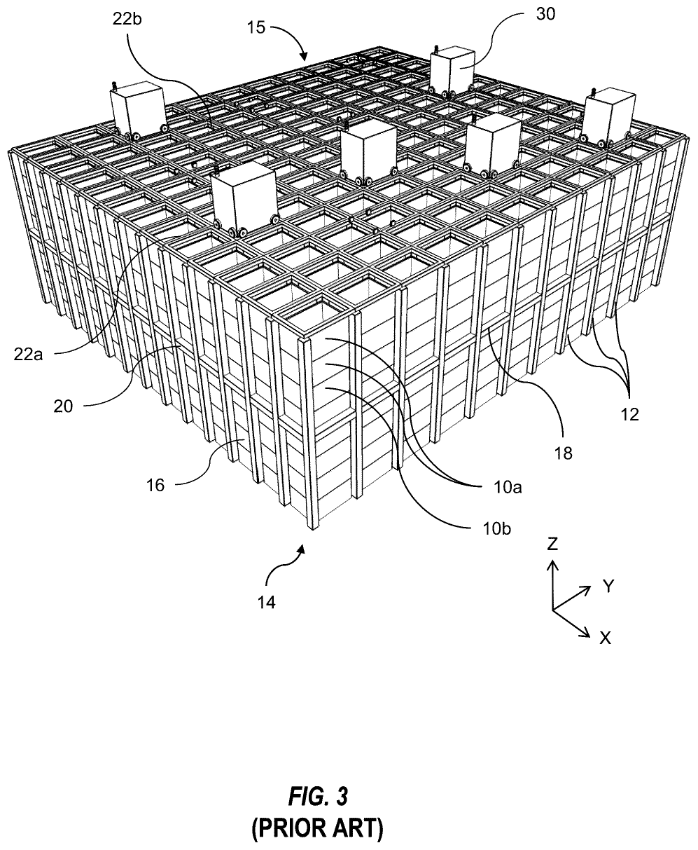

The top level of the grid framework structure 14 comprises a grid or grid structure 15, including rails 22 arranged in a grid pattern across the top of the stacks 12. Referring to FIG. 3, the rails or tracks 22 guide a plurality of load-handling devices 30. A first set 22a of parallel rails 22 guide movement of the robotic load-handling devices 30 in a first direction (e.g. an X-direction) across the top of the grid framework structure 14. A second set of rails 22b of parallel rails 22, arranged perpendicular to the first set 22a, guide movement of the load-handling devices 30 in a second direction (e.g. a Y-direction), perpendicular to the first direction. In this way, the rails 22 allow the robotic load-handling devices 30 to move laterally in two dimensions in the horizontal X-Y plane. A load-handling device 30 can be moved into position above any of the stacks 12.

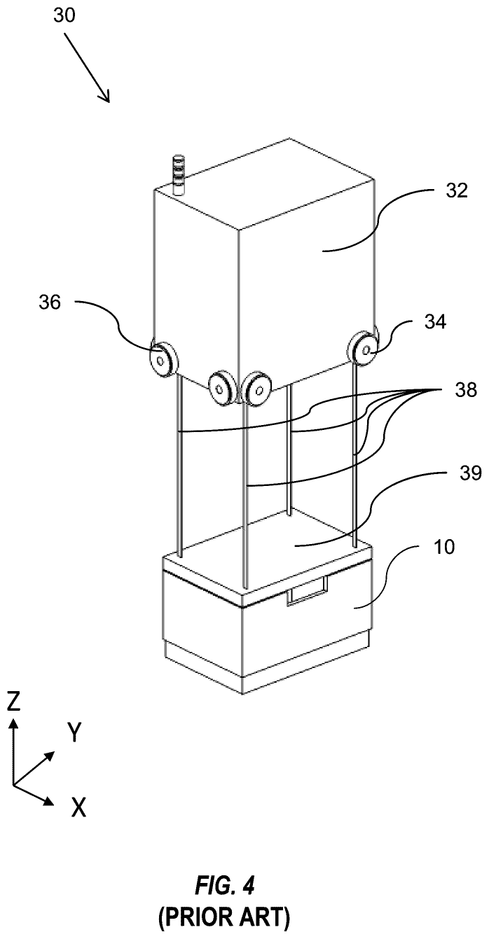

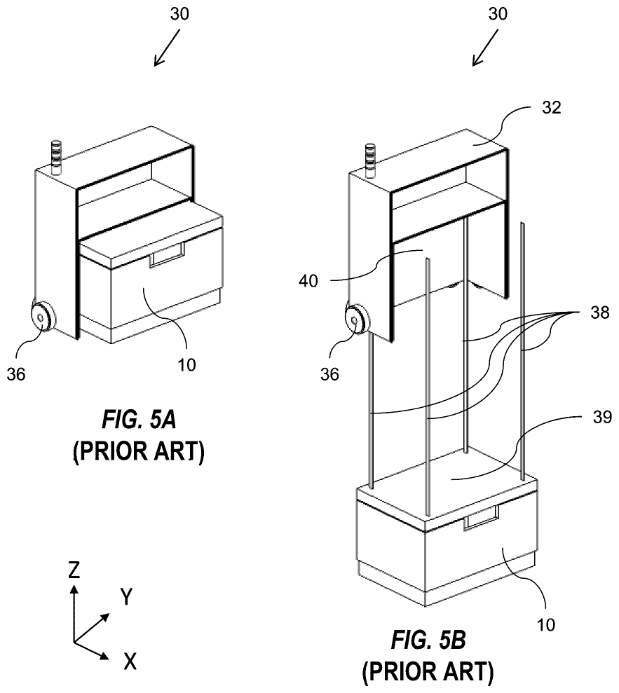

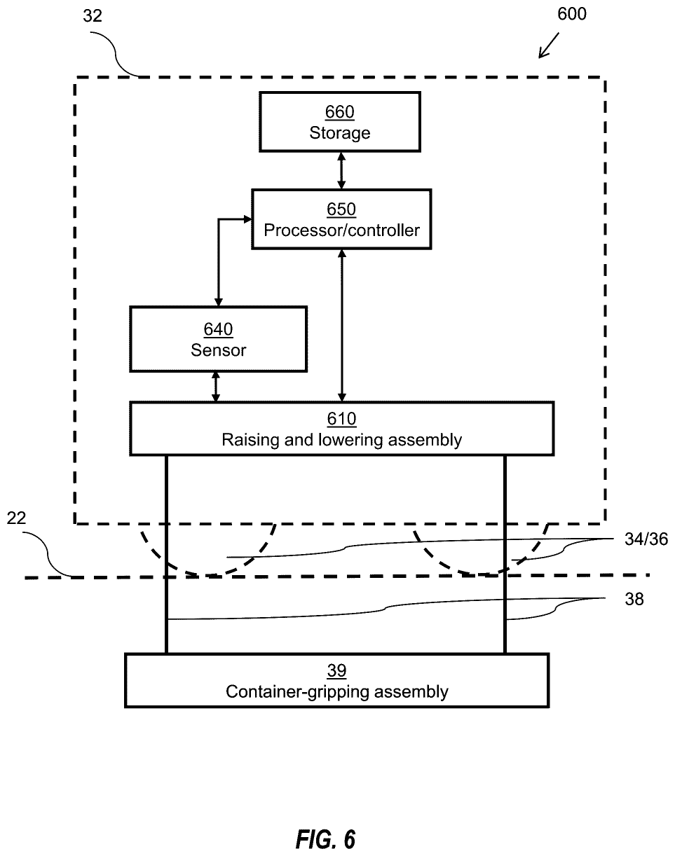

A known form of load-handling device 30—shown in FIGS. 4-5B—is described in PCT Patent Publication No. WO2015/019055 (Ocado), hereby incorporated by reference, where each load-handling device 30 covers a single grid space 17 of the grid framework structure 14. This arrangement allows a higher density of load handlers and thus a higher throughput for a given sized system.

The load-handling device 30 comprises a vehicle 32, which is arranged to travel on the rails 22 of the grid framework structure 14. A first set of wheels 34, consisting of a pair of wheels 34 on the front of the vehicle 32 and a pair of wheels 34 on the back of the vehicle 32, is arranged to engage with two adjacent rails of the first set of rails 22a of rails 22. Similarly, a second set of wheels 36, consisting of a pair of wheels 36 on each side of the vehicle 32, is arranged to engage with two adjacent rails of the second set of rails 22b of rails 22. Each set of wheels 34, 36 can be lifted and lowered, by way of a direction-change assembly, so that either the first set of wheels 34 or the second set of wheels 36 is engaged with the respective first set of rails 22a or second set of rails 22b at any one time. For example, when the first set of wheels 34 is engaged with the first set of rails 22a and the second set of wheels 36 is lifted clear from the rails 22, the first set of wheels 34 can be driven, by way of a drive assembly, housed in the vehicle 32, to move the load-handling device 30 in the X-direction. To achieve movement in the Y-direction, the first set of wheels 34 is lifted clear of the rails 22, and the second set of wheels 36 is lowered into engagement with the second set of rails 22b of rails 22. The drive assembly can then be used to drive the second set of wheels 36 to move the load-handling device 30 in the Y-direction.

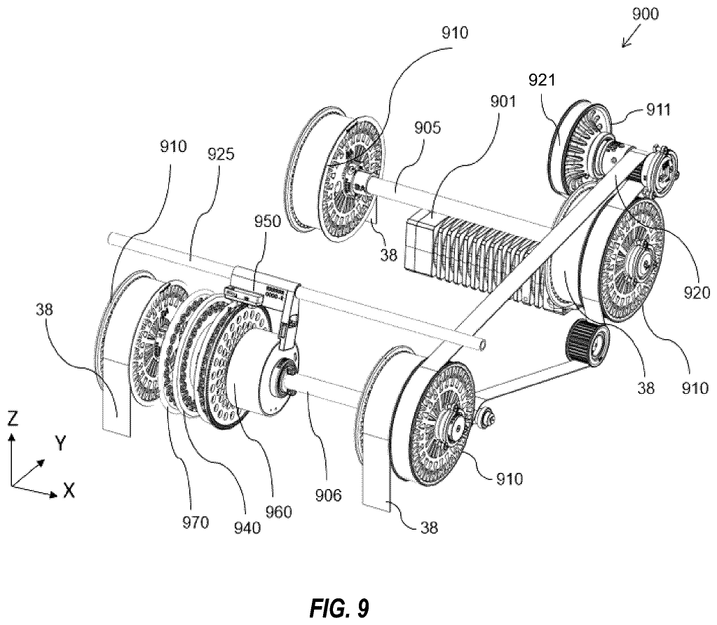

The load-handling device 30 is equipped with a container-lifting device or assembly, e.g. a crane mechanism, to lift a storage container from above. The container-lifting assembly comprises a raising and lowering assembly (an example of which is shown in FIG. 9) with a winch tether or cable 38 wound on a spool or reel, and a container-gripping assembly 39. The raising and lowering assembly also comprises a motor to rotate the spools and thus wind and/or unwind the tethers. The raising and lowering assembly shown in FIG. 4 comprises a set of four tethers 38 for lifting, extending in a vertical direction. The tethers 38 are connected at or near the respective four corners of the container-gripping assembly 39, e.g. a lifting frame, for releasable connection to a container 10. For example, a respective tether 38 is arranged at or near each of the four corners of the container-gripping assembly 39. The container-gripping assembly 39 is configured to releasably grip the top of a container 10 to lift it from a stack of containers in a storage system of the type shown in FIG. 1 and FIG. 2. For example, the container-gripping assembly 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the container-gripping assembly 39, powered and controlled by signals carried through the tethers 38 themselves or a separate control cable (not shown).

To remove a bin 10 from the top of a stack 12, the load-handling device 30 is first moved in the X- and Y-directions to position the container-gripping assembly 39 above the stack 12. The container-gripping assembly is then lowered vertically in the Z-direction, by the raising and lowering assembly to engage with the bin 10 on the top of the stack 12, as shown in FIG. 4 and FIG. 5B. The container-gripping assembly 39 grips the bin 10, and is then pulled upwards by the tethers 38, with the bin 10 attached. At the top of its vertical travel, the bin 10 is held above the rails 22 accommodated within the body of vehicle 32. In this way, the load-handling device 30 can be moved to a different position in the X-Y plane, carrying the bin 10 along with it, to transport the bin 10 to another location. On reaching the target location (e.g. another stack 12, an access point in the storage system, or a conveyor belt) the bin or container 10 can be lowered from the container receiving portion and released from the container-gripping assembly 39. The tethers 38 are long enough to allow the load-handling device 30 to retrieve and place bins from any level of a stack 12, e.g. including the floor level.

As shown in FIG. 3, a plurality of identical load-handling devices 30 is provided so that each load-handling device 30 can operate simultaneously to increase the system's throughput. The system illustrated in FIG. 3 may include specific locations, known as ports, at which bins 10 can be transferred into or out of the system. An additional conveyor system (not shown) is associated with each port so that bins 10 transported to a port by a load-handling device 30 can be transferred to another location by the conveyor system, such as a picking station (not shown). Similarly, bins 10 can be moved by the conveyor system to a port from an external location, for example, to a bin-filling station (not shown), and transported to a stack 12 by the load-handling devices 30 to replenish the stock in the system.

Each load-handling device 30 can lift and move one bin 10 at a time. The load-handling device 30 has a container-receiving cavity or recess 40, in its lower part. The recess 40 is sized to accommodate the container 10 when lifted by the lifting mechanism, as shown in FIGS. 5A-5B. When in the recess, the container 10 is lifted clear of the rails 22 beneath, so that the vehicle 32 can move laterally to a different grid location. If it is necessary to retrieve a target bin 10b that is not located on the top of a stack 12, then the overlying or non-target bins 10a must first be moved to allow access to the target bin 10b. This is achieved by an operation referred to hereafter as “digging”. Referring to FIG. 3, during a digging operation, one of the load-handling devices 30 lifts each non-target bin 10a sequentially from the stack 12 containing the target bin 10b and places it in a vacant position within another stack 12. The target bin 10b can then be accessed by the load-handling device 30 and moved to a port for further transportation.

Each of the provided load-handling devices 30 is remotely operable under the control of a central computer. Each individual bin 10 in the system is also tracked so that the appropriate bins 10 can be retrieved, transported and replaced as necessary. For example, during a digging operation, each non-target bin location is logged so that the non-target bin 10a can be tracked.

Wireless communications and networks may be used to provide the communication infrastructure from the central computer, e.g. via one or more base stations, to one or more load-handling devices operative on the grid structure. In response to receiving instructions from the central computer, a controller in the load-handling device is configured to control various driving mechanisms to control the movement of the load-handling device. For example, the load-handling device may be instructed to retrieve a container from a target storage column at a particular location on the grid structure. The instruction can include various movements in the X-Y plane of the grid structure 15. As previously described, once at the target storage column, the container-lifting assembly can be operated to grip and lift the container 10 using the raising and lowering assembly and the container-gripping assembly 39. Once the container 10 is accommodated in the recess 40 of the load-handling device 30, it is subsequently transported to another location on the grid structure 15, e.g. a “drop-off port”. At the drop-off port, the container 10 is lowered to a suitable pick station to allow retrieval of any item in the storage container. Movement of the load-handling devices 30 on the grid structure 15 can also involve the load-handling devices 30 being instructed to move to a charging station, usually located at the periphery of the grid structure 15.

To manoeuvre the load-handling devices 30 on the grid structure 15, each of the load-handling devices 30 is equipped with motors for driving the wheels 34, 36. The wheels 34, 36 may be driven via one or more belts connected to the wheels or driven individually by a motor integrated into the wheels. For a single-cell load-handling device (where the footprint of the load-handling device 30 occupies a single grid space 17), and the motors for driving the wheels can be integrated into the wheels due to the limited availability of space within the vehicle body. For example, the wheels of a single-cell load-handling device are driven by respective hub motors. Each hub motor comprises an outer rotor with a plurality of permanent magnets arranged to rotate about a wheel hub comprising coils forming an inner stator.

The system described with reference to FIGS. 1-5 has many advantages and is suitable for a wide range of storage and retrieval operations. In particular, it allows very dense storage of products and provides a very economical way of storing a wide range of different items in the bins 10 while also allowing reasonably economical access to all of the bins 10 when required for picking.

During storage and retrieval operations, the container-lifting assembly uses the raising and lowering assembly (examples of which are shown in FIGS. 4-5B, 8, and 9) to raise and/or lower the container-gripping assembly in the Z-direction. The extent to which a container-gripping assembly is raised or lowered varies across the grid framework structure 14. Each stack of containers of the grid framework structure 14 will have a current dimension/height in the Z-direction defined by the number of containers currently in that stack. The current dimension/height in the Z-direction can be determined by tracking, via the central computer for example, containers that have been raised from and/or lowered to each stack of containers. For example, if a stack currently has 10 containers, where the containers are of a fixed dimension/height in the Z-direction, it can be determined that the current dimension/height of the stack in the Z-direction is 10 times the fixed dimension/height of a container in the Z-direction. It will be appreciated that the current dimension/height of the stack in the Z-direction can be expressed in an absolute sense for example n metres from ground, or a relative position, for example n metres from bottom of the grid framework structure 14, or n metres from the top of the grid storage structure.

The current dimension/height in the Z-direction of a stack of containers over which a load-handling device is located can be communicated to that load-handling device. The raising and lowering assembly of the load-handling device can use the current dimension/height in the Z-direction of the stack of containers to control the raising and lowering of the container-gripping assembly throughout an operation to obtain or replace a container from or to the grid storage structure. To control the raising and or lowering of the container-gripping assembly in this way, the Z-position (or vertical position, or the position in a direction perpendicular to the plane (i.e. defined by the X- and Y-directions) along which the bot moves across the grid storage structure) of the container-gripping assembly should be known. It will be appreciated that the Z-position may be an absolute position, for example n metres from ground, or a relative position, for example n metres from the container-receiving cavity or recess 40, or n metres from the top of the grid storage structure, or n metres from the top of the top container in the stack of containers over which the load-handling device is located. The Z-position allows determination of how close the container-gripping assembly is to the load-handling device and/or the top of the top container in the stack of containers. This way, the container-gripping assembly can be controlled appropriately, such as accelerating after being lowered from the load-handling device and decelerating when approaching the top of the top container in the stack of containers. Similarly, the container-gripping assembly can accelerate after being raised from the top of the top container in the stack of containers and decelerate when approaching the load-handling device.

During a raising or lowering of the container-gripping assembly the container gripping-assembly may become obstructed. For example, the container-gripping assembly may encounter a defect in the grid framework structure 14 such that the container-gripping assembly cannot be raised or lowered smoothly. One such example defect may be where a vertical member 16 that has a protrusion that contacts the container-gripping assembly. Another example defect is where it is not recognised that the container-lifting assembly has contacted the top container within a stack, and keeps unwinding the tethers. The excess tether could unwind onto an adjacent stack and cause an obstruction in that stack. Yet another defect is where the container-gripping assembly is no longer parallel with the X-Y plane as it is raised and lowered to the extent one side of the container-gripping assembly contacts a vertical member 16 about which the container-gripping assembly then pivots, potentially into a vertical orientation. In any of these cases, the container-gripping assembly is therefore obstructed from operating correctly.

It is therefore advantageous to determine accurately the Z-position of the container-gripping assembly throughout a raising and/or lowering thereof. It is also advantageous to determine whether the container-gripping assembly has been obstructed during raising and lowering thereof, and that the tethers 38 are slack for example. Although the Z-position and obstruction has been described in the context of a load-handling device, it will be appreciated that it is useful to determine the Z-position and obstruction of a gripping-assembly in any lifting arrangement, such as a crane (i.e. lifting arrangement) with a motor and tether (i.e. a raising and lowering assembly) with a hook (i.e. a gripping assembly) that grips and raises and/or lowers a load.

FIG. 6 shows a schematic 600 of load-handling device 30 in accordance with the invention. The dashed lines show the body of vehicle 32 of a load-handling device that travels on rails 22 via wheels 34/36. A raising and lowering assembly 610 (such as that shown in FIGS. 4-5B, 8, and 9) driven by a motor (not shown) raises and lowers container-gripping assembly 39 by winding and unwinding tethers 38. One or more sensors 640 is configured to detect movement of the container-gripping assembly. Load-handling device 30 can use processor or controller 650 to receive and transmit data from and to each of the raising and lowering assembly 610, and one or more sensors 640. This data can be stored in storage 660. The data in storage 660 can be periodically transmitted for further processing via one or more networks, such as base stations.

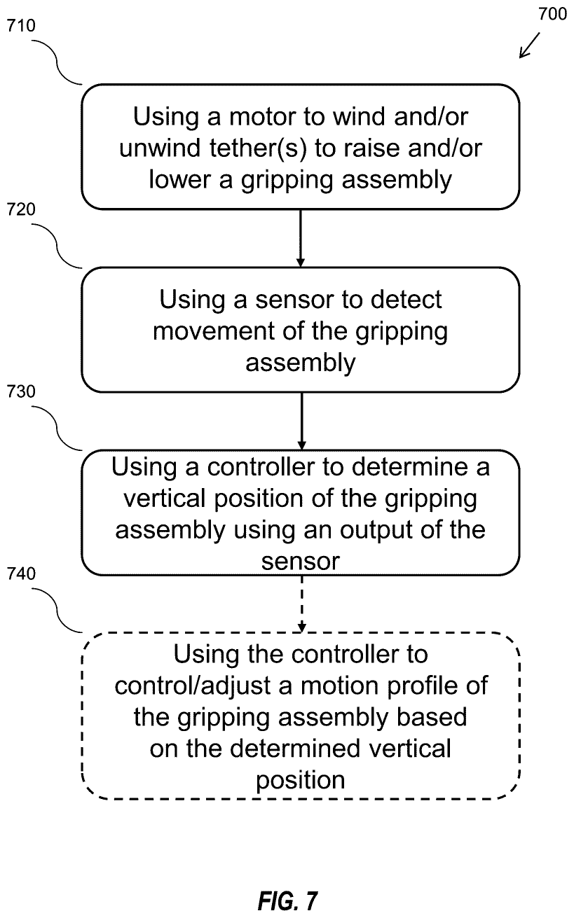

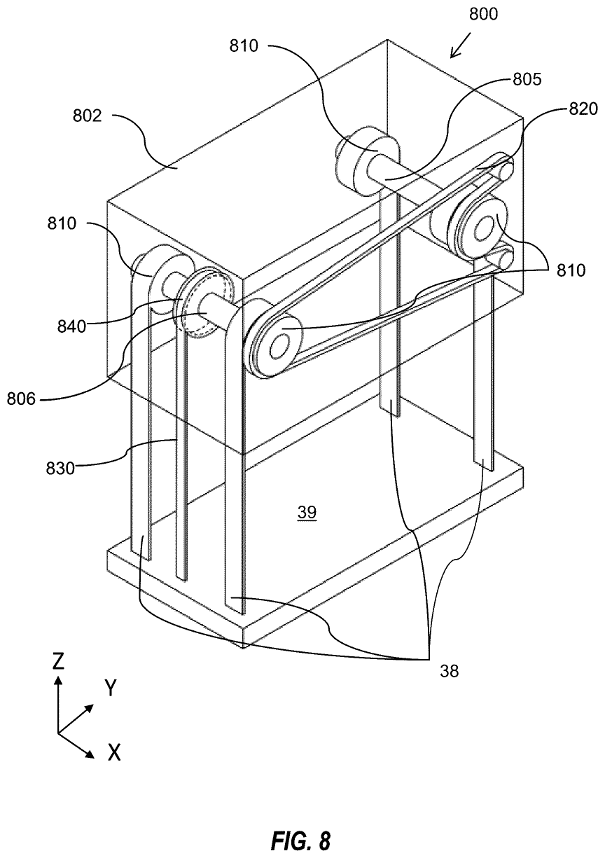

FIG. 7 shows the steps of a method 700 for use in a lifting assembly (such as that used in a load-handling device or a crane) comprising a gripping assembly configured to grip a load, a raising and lowering assembly configured to raise and lower the gripping assembly, where the raising and lowering assembly comprises at least one tether connected to the gripping assembly, and a motor to wind and/or unwind the or each tether to raise and/or lower the gripping assembly. It would be appreciated that the method of FIG. 7 could be carried out using a controller (such as controller 650 of a load-handling device of FIG. 6 for example). In step 710, a motor of the raising and lowering assembly is used to raise and/or lower the gripping assembly, as shown in FIG. 8 or FIG. 9 for example. In step 720, a sensor is used to detect movement of the gripping assembly. Examples of sensors that are configured to detect movement of the gripping assembly are described below in relation to FIGS. 9-15. In general, the sensor comprises an input that is engaged by movement of the gripping assembly. In step 730, the controller is used to determine a vertical position of the gripping assembly using an output of the sensor. It will be appreciated that the detected movement of the gripping assembly can be correlated to vertical position. For example, if it is detected that a tether (or FFC) has unwound 1 metre from the raising and lowering assembly, the vertical position of the gripping assembly has changed relatively by 1 metre. If the starting position of the gripping assembly to the 1 metre unwinding is known in absolute terms (for example determined from when the gripper device is fully retracted within a recess 40 of a load-handling device 30 located on a grid framework structure 14) the current absolute vertical position of the gripper assembly can be determined. In optional step 740, the controller is used to control/adjust a motion profile of the gripping assembly based on the determined vertical position. Typically, a motor is controlled using a motion profile. In the example of a load-handling device, the motor controls the raising and/or lowering of the container-gripping assembly according to a motion profile. One such example is a trapezoidal velocity versus time motion profile, which should result in the container-gripping assembly being at a specific vertical position at a specific time. Monitoring this vertical position can thus provide feedback that is used to control/adjust the motion profile.

An example container-lifting assembly (further described in PCT application no. PCT/EP2022/081364 (Ocado)) is shown in FIG. 8. In FIG. 8, a container-lifting assembly 800 has a raising and lowering mechanism 802 including four spools 810 to wind and unwind respective tethers 38. A drive belt 820 is driven by a motor (not shown) to rotate the spools on drive shaft 805 in an opposite direction to drive shaft 806. By rotating drive shafts 805 and 806 in opposite directions, respective tethers 38 can be located at or near the corners of the raising and lowering assembly. In particular, as shown in FIG. 8, the point at which each tether winds or unwinds to or from a spool is at or near a respective corner of the raising and lowering assembly. This allows the tethers to connect to the container-gripping assembly 39 at a respective corner of the container-gripping assembly, which increases stability when raising and lowering the container-gripping assembly 39.

The tether(s) may be in the form of cables, or ropes, or tapes, or any other form of tether with the necessary physical properties to lift the containers. In one implementation, four tethers are used. In one implementation, the tethers may comprise steel tape. In one implementation, the tethers may be formed of or comprise polyester material (e.g. woven polyester material). In particular, the tethers may comprise woven polyester tapes or belts, e.g. seat belts (i.e. seat belts may be used as the tethers). In another implementation, the tethers may be made from ultra-high-molecular-weight polyethylene, UHMVPE or UHMW, (also known as high-modulus polyethylene, HMPE), such as Dyneema® tape. In another implementation, the tethers may comprise polyester material (e.g. woven polyester) combined with Dyneema® tape. In another implementation, the tethers may comprise cotton material. In another implementation, the tethers may comprise webbing material, e.g. webbed polyester, nylon, cotton. In another implementation, the tethers may comprise conductive material, for example the tethers may comprise woven material or woven polyester material with a conductive element or wiring (e.g. copper) woven into the weave or fabric of the tethers. In another implementation, the tethers may comprise woven belts (e.g. seat belts) with a conductive element or wiring woven into the belt. In another implementation, the tethers may comprise a conductive element or wiring (e.g. copper) woven into the weave or fabric of the tethers so as to provide power and/or communication (i.e. electrical communication) to the gripping device.

Also shown is an optional FFC 830 (which could alternatively be ribbon cable) and FFC spool 840 for communicating electrical signals to the container-gripping assembly 39 to power and control a gripping of a container as described above in respect of FIG. 4. That is, the FFC is used to power and control pins or clips that engage with the bin 10 by a suitable drive mechanism housed within the container-gripping assembly 39. One suitable FFC is that made by Axon' Cable®. Although an FFC is shown, it will be appreciated that at least one electrical wire may be used instead for the same purpose, or as explained above, a conductive element can be integrated with a tether.

Systems that use the method of FIG. 7 to determine vertical position of the container-gripping assembly are described below. Although the lifting assembly shown in FIG. 8 (and FIG. 9 below) is shown having four spools 810 and respective tethers, that raise and lower the container-gripping assembly using the shown configuration, it will be appreciated that the systems described below are not limited to a specific number of spools, tethers and the shown configuration to raise and or lower the container-gripping device.

With reference to FIGS. 9-11B, a container-lifting assembly 900 with a sensor that can determine the vertical position of the container-gripping assembly is described. Similar to FIG. 8, a raising and lowering assembly includes four tether spools 910 to wind and unwind respective tethers 38. A drive belt 920 is driven (via drive belt 921 and tether spool 911) by a motor 901 to rotate the spools on drive shaft 905 in an opposite direction to drive shaft 906. The drive belt 920 drives pulleys connected to tether spools 910. By rotating drive shafts 905 and 906 in opposite directions, respective tethers 38 can be located at or near the corners of the raising and lowering assembly. In particular, as shown in FIG. 9, the point at which each tether winds or unwinds to or from a spool is at or near a respective corner of the raising and lowering assembly. This allows the tethers to connect to the container-gripping assembly 39 (not shown) at a respective corner of the container-gripping assembly, which increases stability when raising and lowering the container-gripping assembly 39. Container-lifting assembly also includes FFC spool 940. An FFC (not shown) is wound on the spool and extends to the container-gripping assembly 39 for communicating electrical signals to the container-gripping assembly 39. Therefore, the FFC will wind and unwind as the motor rotates drive shaft 906. A stator 960 is used to transmit signals to and from the FFC on the FFC spool 940.

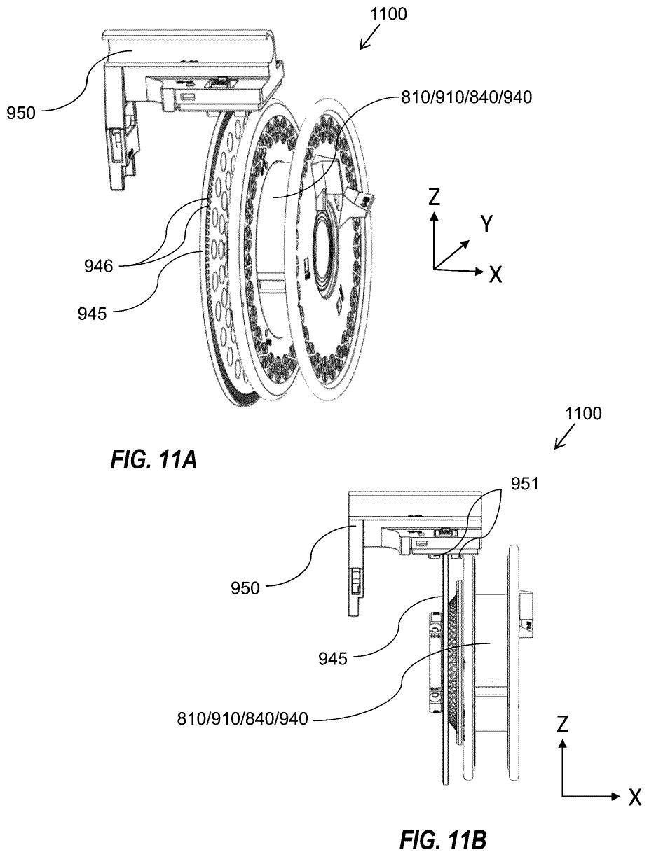

In one implementation, the FFC spool 940 has a rotary encoder 950 (i.c. a sensor) to detect movement of the FFC spool 940. As an example, the rotary encoder 950 can be held in place between the stator and a stationary shaft 925 (although other means of interfacing the rotary encoder 950 with the FFC spool will be apparent). The rotary encoder 950 comprises a rotary electromechanical device that generates pulses when the FFC spool rotates. For example, a pulse is generated for a predetermined amount of angular rotation of the FFC spool. As shown in FIGS. 11A-11B, an encoder arrangement 1000 has an encoder disc 945 attached to the FFC spool 840/940. The encoder disc 945 has slots 946 around its perimeter (or outer circumference). The slots allow a transmitter and receiver elements 951 of the rotary encoder 950 to transmit and receive an optical signal. The solid space between the slots will prevent reception of the optical signal. Thus, the optical signal will be received and interrupted as the FFC spool rotates, which can be correlated into an angular rotation of the FFC spool 940. Whilst an optical rotary encoder has been described, a mechanical encoder can alternatively be used where the FFC spool 940 engages directly with an input of the mechanical encoder to rotate the input. Alternatively, the motor 901 may have an encoder that can be used to determine the number of rotations of the FFC spool 940. No matter the type of the rotary encoder implementation, the angular rotation and direction of the FFC spool 940 can be determined as the container-gripping assembly 39 is raised and lowered.

Using the dimensions of the FFC spool 940 and the FFC, the angular rotation and direction of the FFC spool 940 can be correlated to the length of the FFC that currently extends from the FFC spool. The length of the FFC that currently extends from the FFC spool 940 can be correlated to the vertical position of the container-gripping assembly as explained above for FIG. 7.

Whilst the use of the rotary encoder 950 has been described for use with the FFC spool 840/940, it will be appreciated that any of the tether spools 810/910 can be monitored using the encoder arrangement 1100 depicted in FIGS. 11A-11B. That is, an encoder disc is attached to tether spool 810/910. Therefore, the rotation of a tether spool 910 can be monitored instead. Using the dimensions of the tether spool 910 and the tether 38, the angular rotation of the tether spool 910 can be correlated to the length of tether currently extending from the tether spool 910, which can be correlated to the vertical position of the container-gripping assembly as explained above for FIG. 7. Alternatively, the motor 901 may have a motor encoder that can be used to determine the number of rotations of the tether spool 910. No matter the type of the rotary encoder implementation, the angular rotation and direction of the tether spool 910 can be determined as the container-gripping assembly 39 is raised and lowered.

It will also be appreciated that an encoder arrangement 1100, as shown in FIGS. 11A-11B, may be used to monitor a respective tether spool 810/910 and FFC spool 840/940. Using two encoder arrangements 1100 allows for redundancy should one of the encoder arrangements fail. Using two encoder arrangements 1100 on respective tether spools 910 allows the determination of whether the container-gripping assembly 39 is level during a lifting or raising operation. If the two encoder arrangements 1100 detect the same angular rotation of respective tether spools 910, it can be deduced that the container-gripping assembly 39 is level. This may occur if one tether spool slips on the shaft about which it rotates. One of the encoder arrangements 1100 having an output that deviates from the other encoder arrangement 1100 may indicate that the container-gripping assembly 39 is not level. The use of four encoder arrangements 1100 allows for the orientation of container-gripping assembly to be detected.

Using the FFC spool 940 to determine the vertical position of the container-lifting assembly can be advantageous when the FFC has a relatively higher modulus of elasticity than the tethers 38, for example when a woven polyester belt is used for the tethers 38. A woven polyester belt tends to stretch when unwinding and winding depending on the load carried by the container-gripping assembly 39. Similarly, the woven polyester belts tend to unwind from and wind to spools 910 in an unpredictable way. In comparison, the FFC is less prone to stretching and unwinds from and winds to FFC spool in a predictable way, so detected movement of the FFC spool results in more accurate determination of the vertical position of the container-gripping assembly 39.

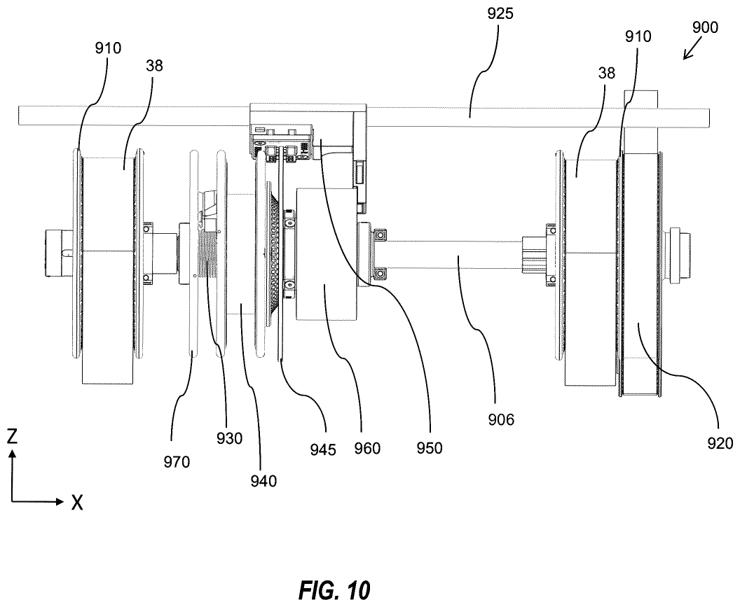

Additionally, or alternatively, the FFC spool 940 can be rotatably mounted on drive shaft 906, via a bearing for example, so that the FFC spool 940 can rotate independently of or relatively to drive shaft 906. The FFC spool 940 will therefore unwind and allow the FFC cable to extend as the tethers are unwound to lower the container-gripping assembly 39. Additionally, the FFC does not carry the load of the container-gripping assembly 39. To ensure that the FFC will wind back onto FFC spool 940 as the container-gripping assembly 39 is raised, a biasing assembly can be used. The biasing assembly opposes the unwinding of the FFC such that the FFC remains taut, which ensures a more accurate determination of the vertical position of the container-gripping assembly 39. For example, if it is determined the FFC has extended 1 metre from FFC spool 940, and the FFC is taut, it can be determined that the container-gripping assembly's position has changed by 1 metre. As shown in FIG. 10, the biasing assembly comprises biasing plate 970 and torsion spring 930 that acts on the FFC spool 940 that is rotatably mounted on drive shaft 906. The biasing plate 970 is fixedly mounted to drive shaft 906. The torsion spring 930 is connected to biasing plate 970 and FFC spool 940 such that unwinding of the FFC spool 940 is opposed. In other words, the FFC spool 940 is spring-loaded such that applying a rotational force (within the torsion spring's elastic limit) thereto in an unwinding direction relative to a stationary shaft 925, is opposed. The FFC spool will thus wind back up on removal of this rotational force (within the torsion spring's elastic limit). In general, any biasing assembly can be used, provided the biasing assembly acts on the rotatably mounted FFC spool 940 to maintain the FFC in a taut state. For example, a tension spring can be used to connect the biasing plate 970 and FFC spool 940. Alternatively, the FFC spool 940 may be fixedly mounted to drive shaft 906 and the biasing arrangement may be located in the container-gripping assembly 39. The biasing arrangement in this implementation opposes the winding of the FFC spool 940. This ensures the FFC remains taut during a raising and lowering of the container-gripping assembly 39.

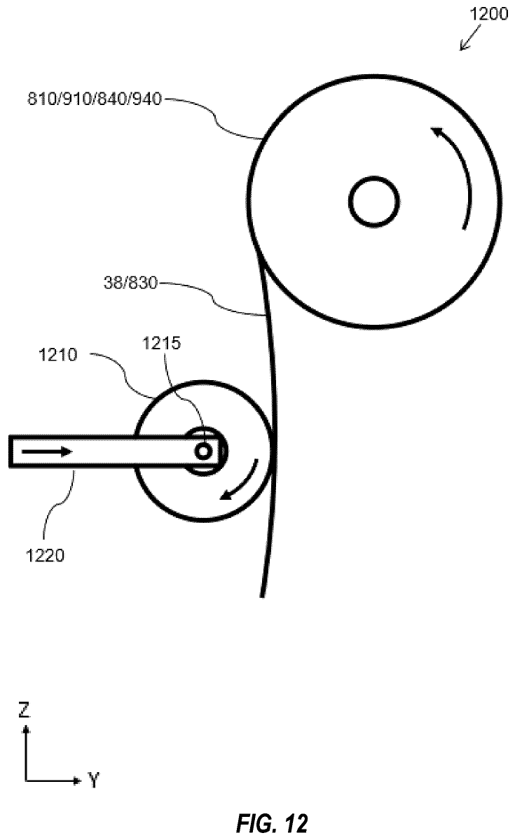

With reference to FIG. 12, another sensor 1200 that can determine the vertical position of the container-gripping assembly is described. A spool, which could be any of spools 810/910/840/940 is used to wind and or unwind a respective tether 38 or FFC 830. A rotary encoder wheel 1210 is biased against the tether 38 or FFC 830 using arm 1220 about which the rotary encoder wheel 1210 rotates via pivot 1215. As shown in FIG. 12, the rotary encoder wheel 1210 rotates as the tether 38 or FFC 830 moves during winding and/or unwinding from the spool 810/910/840/940. That is, a shaft/input of rotary encoder wheel is rotated by a tether 38 or FFC 830. The rotary encoder wheel's 1210 rotation can be correlated to a length of tether 38 or FFC 830 that effected that rotation, which can then be correlated to vertical position of the container-gripping assembly in line with the implementations above. The encoder wheel can be part of an optical or a mechanical encoder.

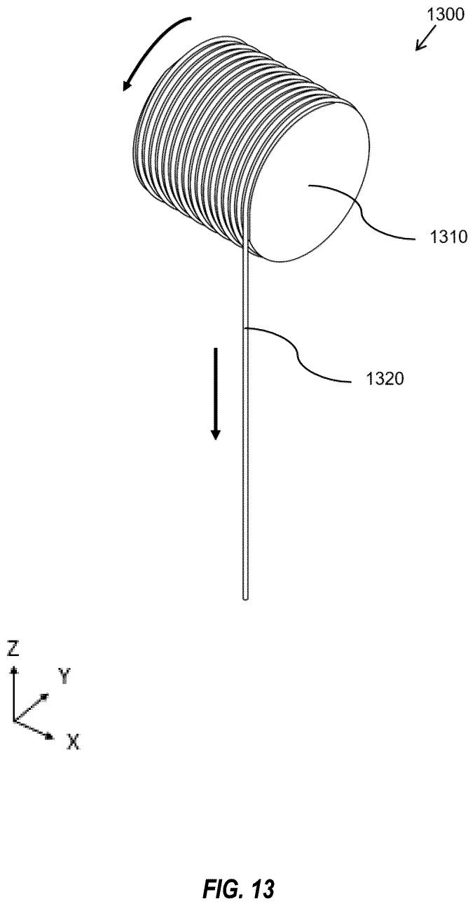

With reference to FIG. 13, another sensor 1300 that can determine the vertical position of the container-gripping assembly is described. An electrical wire spool 1310 can be mounted on shaft 805/806/905/906. Electrical wire spool 1310 therefore rotates as the raising and lowering assembly raises and lowers the container-gripping assembly. The electrical wire spool 1310 can be electrically conductive. Additionally, or alternatively, the spool 1320 has a channel or groove that allows electrically conductive wire 1320 to be wound in way such that the wire in adjacent channels/grooves is in physical contact. This means that in a fully wound electrical wire spool 1310, the electrically conductive wire 1320 is short-circuited and a voltage applied across a first end (connected to the electrical wire spool) 1310 and second end (connected to the container-gripping assembly) of the electrically conductive wire 1320 will return a given current value. As the electrical wire spool 1310 unwinds, a length of the electrically conductive wire 1320 is no longer be short-circuited, as shown in FIG. 13. Thus, a voltage applied across the first and second ends of the electrically conductive wire 1320 will return a reduced current value, due to the increased electrical resistance of the electrically conductive wire's 1320 configuration. In one implementation, the second end may connect to the FFC connection on the container-gripping assembly 39 to form a closed circuit that allows the current value to be determined. The change in electrical resistance as the electrically conductive wire 1320 winds and unwinds can be correlated to a length of electrically conductive wire (and thus tether 38 or FFC 830) that effected that change in electrical resistance, which can then be correlated to vertical position of the container-gripping assembly in line with the implementations above. A biasing assembly (such as those described above in relation to the FFC spool can be used with electrical wire spool 1310) provided the biasing assembly maintains the spool in a taut stat. That is, the biasing assembly opposes the winding or the unwinding of electrical wire spool 1310 as described above in relation to the FFC spool.

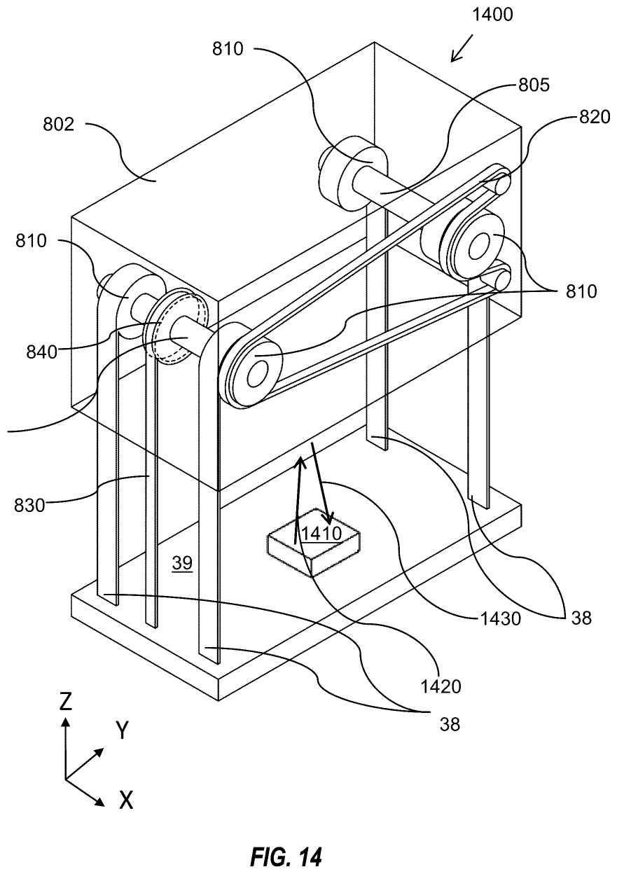

With reference to FIG. 14, another sensor 1400 that can determine the vertical position of the container-gripping assembly is described. FIG. 14 shows the same arrangement described above in respect of FIG. 8. The description of FIG. 8 applies to what is shown in FIG. 8. Additionally, a time-of-flight (ToF) sensor 1410 is mounted on the container-gripping assembly 39. The ToF sensor 1410 is configured to transmit an optical signal 1420 to a reflective surface (not shown) and receive a reflection 1430 of the transmitted optical signal 1420. The time between transmission and reception of the optical signal (laser or LED for example) can be used to calculate a distance between the container-gripping assembly 39 and the reflective surface. The reflective surface does not move as the container-gripping assembly 39 is raised and or lowered. For example, the reflective surface may be located in the raising and lowering mechanism 802 or any other appropriate part of the load-handling device or system. Thus, the distance between the container-gripping assembly 39 and the reflective surface can be used to determine the vertical position of the container-gripping assembly 39. It will be appreciated that the ToF sensor 1410 can instead be located in a fixed location in the raising and lowering mechanism 802 or any other appropriate part of the load-handling device or system and transmit and receive optical signals onto a reflective surface of the container-gripping assembly 39. A suitable ToF sensor is Texas Instruments® OPT3101 ToF-based Long Range Proximity and Distance Sensor AFE Evaluation Module. In general, any laser sensor that measures distance can be used. In principle any rangefinder type senor can be used in this implementation such as light detection and ranging, LiDAR, or ultrasound to implement a ToF sensor.

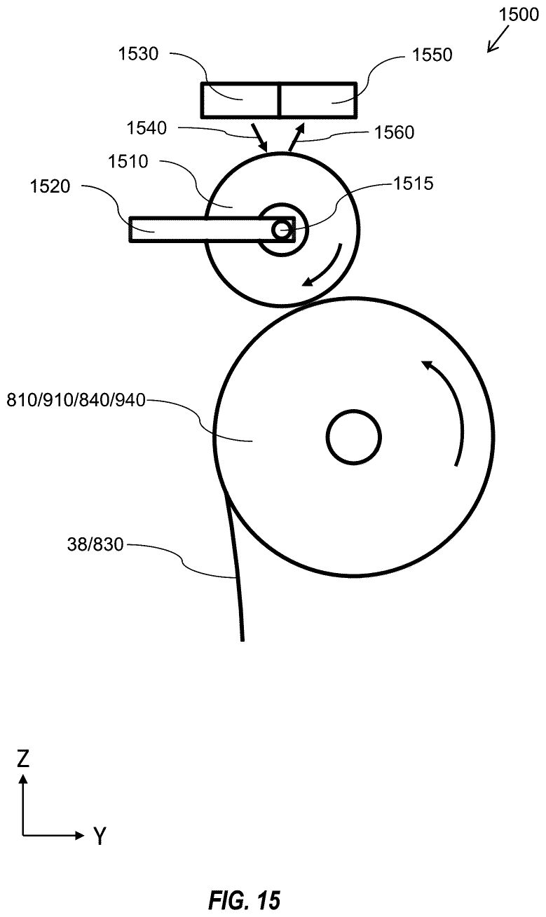

With reference to FIG. 15, another sensor 1500 that can determine the vertical position of the container-gripping assembly is described. A spool, which could be any of spools 810/910/840/940 is used to wind and or unwind a respective tether 38 or FFC 830. A wheel 1510 is biased against the spool 810/910/840/940 using arm 1520 about which the wheel 1510 rotates via pivot 1515. Wheel 1510 rotates as spool 810/910/840/940 rotates as shown in FIG. 15. Wheel 1510 has an outer textured surface that enables sensor 1530 to track its movement. One such suitable surface is aluminium or nylon. Sensor 1530 projects an optical signal (such as laser or LED 1540) onto the outer textured surface of wheel 1510 such that reflected light 1560 can be detected (via a photodiode 1550 for example) to track movement of the outer textured surface of wheel 1510. The operation is similar to that of an optical computer mouse. Detected movement of the outer textured surface of wheel 1510 can be correlated to rotation of spool 810/910/840/940 and thus extension of tether 38 or FFC 830, which can then be correlated to vertical position of the container-gripping assembly in line with the implementations above. It will be appreciated that the wheel 1510 can be omitted if the spool 810/910/840/940 instead has a surface that enables sensor 1530 to track its movement.

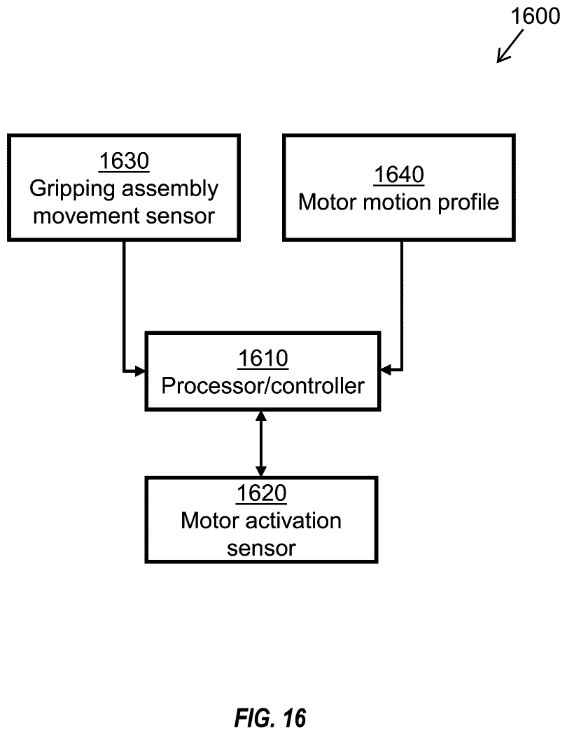

With reference to FIG. 16, a system 1600 that uses the sensors described above to determine an obstruction of the container-gripping assembly 39 is described. The motor 901 effects the winding and unwinding of the tethers 38/830. Therefore, any of the above sensors that directly monitor the motor in effect detect whether the motor is currently active and thus whether the tethers are winding and unwinding. In other words, if the motor has been activated, any of the above sensors which directly monitor the motor will detect activation of the motor. When the container-gripping assembly 39 is obstructed, the motor will continue to wind and or unwind the tethers, whilst the tethers 38/830 and/or the FFC 830 will experience a change of configuration. For example, upon hitting an obstruction on a lowering of the container-gripping assembly 39, the tethers 38/830 and/or the FFC 830 will go slack. Therefore, using sensors described above that can detect a change in state of the tethers 38/830 and/or the FFC 830, in conjunction with sensors that detect the state of the motor 901 can be used to determine an obstruction of the container-gripping assembly 39. In particular, if the motor is active as detected by certain sensors, and the tethers 38/830 and/or the FFC 830 are slack as detected by certain sensors, it can be deduced that an obstruction of the gripping-assembly 39 has occurred. That is, in the case of an obstruction when lowering the container-gripping assembly, the motor is no longer effecting lowering of the container-gripping assembly 39.

The processor/controller 1610 (which may be the same as processor or controller 650), can receive an input from a sensor 1620. Sensor 1620 includes the sensors such as those described above: a motor encoder of motor 901; FFC or tether spool 810/910/840/940 that are monitored using the encoder arrangement 1100 as shown in FIGS. 11A-11B; and that shown in FIG. 15.

All of sensors 1620 either detect motor activation itself directly or via movement of a spool (either FFC or tether spool 810/910/840/940) that is fixed to the shaft rotated by the motor. In general, the sensor 1620 indicates whether the motor is activated and effecting winding and or unwinding of the tethers 38/830. If the motor is rotating a shaft about which the tethers/FFC are wound and/or unwound, it is assumed the container-gripping assembly 39 is being raised and/or lowered.

The processor/controller 1610 can receive different inputs to verify that the container-gripping assembly 39 is indeed being raised and/or lowered. One input that can be used for this purpose is that provided by a sensor 1630 that detects movement of the gripping assembly. Sensor 1630 includes the sensors such as those described above: FFC spool 940, rotary encoder 950 and biasing arrangement shown in FIG. 10; that shown FIG. 12; that shown in FIG. 13 and biasing arrangement; that shown in FIG. 14; and that shown in FIG. 15 when used with FFC spool 940/940 and biasing arrangement.

The output of sensors 1630 depend on movement of the container-gripping assembly 39. That is, sensors 1630 can indicate the extent to which, if at all, the container-gripping assembly 39 is being raised and/or lowered. Therefore, processor/controller 1610 can determine whether motor activation (indicated via sensor 1620) does in fact effect raising and/or lowering of the container-gripping assembly 39 (indicated via sensor 1630).

Alternatively, given sensors 1630 can indicate the extent to which, if at all, the container-gripping assembly 39 is being raised and/or lowered, processor/controller 1610 can correlate the output of a sensor 1630 to a motor motion profile used to control the raising and or lowering of the container-gripping assembly 39. That is, the processor/controller 1610 can determine whether the current raising and/or lowering of the container-gripping assembly 39 (indicated via sensor 1630) correlates to that controlled by the motor. For example, a trapezoidal motion profile of the motor that maps time to velocity of the container-gripping assembly 39 may be converted, by the controller, to a corresponding time to distance profile. Deviations from the determined vertical position of the container-gripping assembly 39 from the converted time to distance profile can be detected.

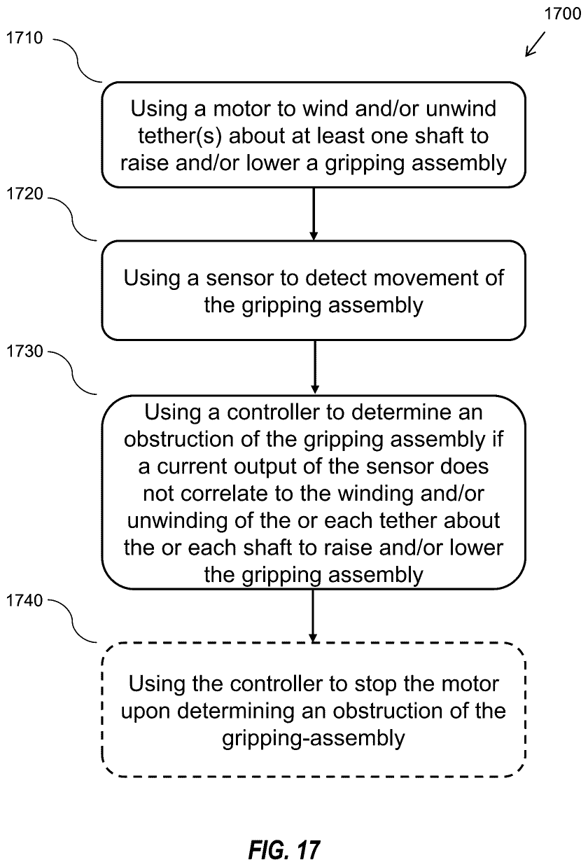

In general, the system of FIG. 16 can be used to determine a mismatch between the driving of the motor and the resultant raising and/or lowering of the container-gripping assembly. The presence of such mismatch can be detected using the method of FIG. 17.

FIG. 17 shows the steps of a method 1700 for use in a lifting assembly (such as that used in a load-handling device or a crane) comprising a gripping assembly configured to grip a load, a raising and lowering assembly configured to raise and lower the gripping assembly, where the raising and lowering assembly comprises at least one tether connected to the gripping assembly, and a motor to wind and/or unwind the or each tether about at least one shaft to raise and/or lower the gripping assembly. It would be appreciated that the method of FIG. 17 could be carried out using a controller (such as controller 650 of a load-handling device of FIG. 6 for example). In step 1710, a motor (such as motor 901) rotates at least one shaft (such as 805,906,905,906) to wind and/or unwind the or each tether (such as tethers 38) to raise and/or lower a gripping assembly (such as container-gripping assembly 39). In step 1720, a sensor (such as sensor 1630) is used to detect movement of the gripping assembly. Examples of sensors 1630 that are configured to detect movement of the gripping assembly are described above in relation to FIGS. 9-15. In step 1730, a controller is used to determine an obstruction of the gripping assembly if a current output of the sensor does not correlate to the winding and/or unwinding of the or each tether about the or each shaft to raise and/or lower the gripping assembly. That is, the controller determines a mismatch between the driving of the motor and the resultant raising and/or lowering of the gripping assembly. Examples of how step 1730 is implemented using sensor 1620 and/or input from motor motion profile 1640 are set out below.

In optional step 1740, the controller is used to stop the motor upon determining an obstruction of the gripping-assembly. This means the tether will not be wound and/or unwound further, thus avoiding damage to the gripping device (such as the container-gripping assembly 39), and/or the lifting device (such as the container-gripping assembly 39), and/or the surrounding environment (such as the grid framework structure 14).

In one implementation of the method of FIG. 17, sensor 1620 is a motor encoder of the motor (such as motor 901), and the controller is configured to determine the obstruction of the gripping assembly if a current output of the sensor does not correlate to a current output of the motor encoder. By way of example only, both the motor encoder and the sensor 1630 can be configured to generate a corresponding output per an increment of rotation of the at least one shaft. Therefore, a deviation in outputs between the motor encoder (i.e. sensor 1620) and the sensor 1630 can be used to indicate that the shaft rotation is no longer effecting raising and/or lowering of the lifting assembly. The controller may be configured to determine the obstruction of the gripper assembly if a current output of the sensor 1630 does not correlate to a current output of the motor encoder by a threshold. The threshold can be set as a matter of course and allows for small deviations before an obstruction is determined. For example, a threshold may require two subsequent outputs to differ.

In another implementation of the method of FIG. 17, a tether spool (such as spool 810/910) for the or each tether on which the or each tether winds and/or unwinds is used. The or each tether spool is fixedly mounted on a shaft rotated by the motor. Sensor 1620 is a tether rotary encoder for the or each tether spool. The or each tether rotary encoder is configured to engage with the or each spool to detect the extent to which the or each spool has rotated as the or each respective tether winds and/or unwinds. Any of the rotary encoders described above such as that shown in FIGS. 11A-11B can be used as a tether rotary encoder. The controller is configured to determine the obstruction of the gripping assembly if a current output of the sensor does not correlate to a current output of the or each tether rotary encoder. By way of example only, both the tether rotary encoder and the sensor 1630 can be configured to generate a corresponding output per an increment of rotation of the at least one shaft. Therefore a deviation in outputs between the or each tether rotary encoder (i.c. sensor 1620) and the sensor 1630 can be used to indicate that the shaft rotation is no longer effecting raising and/or lowering of the lifting assembly. The controller may be configured to determine the obstruction of the gripping assembly if a current output of the sensor 1630 does not correlate to a current output of the tether rotary encoder by a threshold. The threshold can be set as a matter of course and allows for small deviations before an obstruction is determined. For example, a threshold may require two subsequent outputs to differ.

In another implementation of the method of FIG. 17, an electrical cable spool (such as FFC spool 840/940) on which an electrical cable (such as FFC 830) unwinds and winds is used. The electrical cable spool is fixedly mounted on a shaft rotated by the motor. The electrical cable spool is connected to the gripping assembly and electrically communicates therewith. Sensor 1620 is an electrical cable rotary encoder for the electrical cable spool. The electrical cable rotary encoder is configured to engage with the or each spool to detect the extent to which the or each spool has rotated as the or each respective tether winds and/or unwinds. Any of the rotary encoders described above such as that shown in FIGS. 11A-11B can be used as an electrical cable rotary encoder. The controller is configured to determine the obstruction of the gripping assembly if a current output of the sensor does not correlate to a current output of the tether rotary encoder. By way of example only, both the electrical cable rotary encoder and the sensor 1630 can be configured to generate a corresponding output per an increment of rotation of the at least one shaft. Therefore a deviation in outputs between the electrical cable rotary encoder (i.e. sensor 1620) and the sensor 1630 can be used to indicate that the shaft rotation is no longer effecting raising and/or lowering of the lifting assembly. The controller may be configured to determine the obstruction of the grid assembly if a current output of the sensor 1630 does not correlate to a current output of the electrical cable rotary encoder by a threshold. The threshold can be set as a matter of course and allows for small deviations before an obstruction is determined. For example, a threshold may require two subsequent outputs to differ.

In another implementation of the method of FIG. 17, a tether spool (such as spool 810/910) for the or each tether on which the or each tether winds and/or unwinds is used. The or each tether spool is fixedly mounted on a shaft rotated by the motor. Sensor 1620 comprises a tether spool sensor comprising a light source and a light detector, such as that described above and shown in FIG. 15. As explained above, a light source is configured to transmit an optical signal onto a surface that moves as the gripping assembly is raised and/or lowered. The light detector is configured to detect a reflection of the optical signal from the surface to detect movement of the surface. The raising and lowering assembly comprises a wheel that is in contact with a tether spool on which the or each respective tether winds and/or unwinds, wherein the wheel comprises the surface, or alternatively the or each tether spool comprises the surface. The controller is configured to determine the obstruction of the gripping assembly if a current output of the sensor does not correlate to a current output of the tether spool sensor. By way of example only, both the tether spool sensor and the sensor 1630 can be configured to generate a corresponding output per an increment of rotation of the at least one shaft. Therefore, a deviation in outputs between the or each tether spool sensor (i.e. sensor 1620) and the sensor 1630 can be used to indicate that the shaft rotation is no longer effecting raising and/or lowering of the lifting assembly. The controller may be configured to determine the obstruction of the gripping assembly if a current output of the sensor 1630 does not correlate to a current output of the tether spool sensor by a threshold. The threshold can be set as a matter of course and allows for small deviations before an obstruction is determined. For example, a threshold may require two subsequent outputs to differ.

In another implementation of the method of FIG. 17, an electrical cable spool (such as FFC spool 840/940) on which an electrical cable (such as FFC 830) unwinds and winds is used. The electrical cable spool is fixedly mounted on a shaft rotated by the motor. The electrical cable spool is connected to the gripping assembly and electrically communicates therewith. Sensor 1620 comprises an electrical cable spool sensor comprising a light source and a light detector, such as that described above and shown in FIG. 15. As explained above, a light source is configured to transmit an optical signal onto a surface that moves as the gripping assembly is raised and/or lowered. The light detector is configured to detect a reflection of the optical signal from the surface to detect movement of the surface. The raising and lowering assembly comprises a wheel that is in contact with the electrical cable spool on which electrical cable winds and/or unwinds, wherein the wheel comprises the surface, or alternatively the electrical cable spool comprises the surface. The controller is configured to determine the obstruction of the gripping assembly if a current output of the sensor does not correlate to a current output of the electrical cable spool sensor. By way of example only, both the electrical cable spool sensor and the sensor 1630 can be configured to generate a corresponding output per an increment of rotation of the at least one shaft. Therefore, a deviation in outputs between the electrical cable spool sensor (i.e. sensor 1620) and the sensor 1630 can be used to indicate that the shaft rotation is no longer affecting raising and/or lowering of the lifting assembly. The controller may be configured to determine the obstruction of the gripping assembly if a current output of the sensor 1630 does not correlate to a current output of the electrical cable spool sensor by a threshold. The threshold can be set as a matter of course and allows for small deviations before an obstruction is determined. For example, a threshold may require two subsequent outputs to differ.

The five implementations above use a sensor 1620 that indicates direct activation of the motor to the processor controller that implements the method of FIG. 17.

Additionally, or alternatively, the controller can receive a motion profile such that the expected state of the gripping assembly can be derived. That is, the controller is instructed how the gripping assembly should move. As mentioned above, a motion profile of the motor can be provided to the controller that maps time to velocity of the container-gripping assembly 39. A corresponding time to distance profile may instead be provided, or derived from the motion profile by the processor. Therefore, as soon as the controller detects movement of the gripping assembly, via sensor 1630, the controller can compare movement of the gripping assembly with the expected movement as per that derived from the motion profile. This can be used to further verify that an obstruction has occurred should input from motor motion profile 1640 be used in addition to input from sensor 1620.

The method of FIG. 17 also uses sensor 1630, examples of which are set out below.

In one implementation of the method of FIG. 17, an electrical cable spool (such as FFC spool 840/940) on which an electrical cable (such as FFC 830) unwinds and winds is used. The electrical cable spool is rotatably mounted on a shaft rotated by the motor, such as the FFC spool 940 and biasing arrangement described above and shown in FIG. 9. The electrical cable spool is connected to the gripping assembly and electrically communicates therewith. Sensor 1630 comprises a rotary encoder, such as rotary encoder 950. Upon the gripping assembly being obstructed, the FFC spool 940 of FIG. 9 will return to its biased state. That is, FFC spool and FFC will no longer experience a pull due to the movement of the container-lifting assembly and snap back to its biased state. The return to the bias state will mean the rotary encoder output of sensor 1630 in this implementation will no longer correlate to the output provided by sensor 1620, and an obstruction will be detected as explained above. Additionally, or alternatively, the vertical position of the gripper assembly can be derived from sensor 1630 in this implementation and compared with the input provided by 1640 to determine an obstruction.

In another implementation of the method of FIG. 17, sensor 1630 comprises a rotary encoder, such as rotary encoder wheel 1210 described above and shown in FIG. 12. Upon the gripping assembly being obstructed, the rotary encoder wheel 1210 of FIG. 12 will no longer rotate due to reduced traction with either tether 38 or FFC 830. The loss of traction will mean the rotary encoder output of sensor 1630 in this implementation will no longer correlate to the output provided by sensor 1620, and an obstruction will be detected as explained above.

In another implementation of the method of FIG. 17, an electrical wire spool (such as electrical wire spool 1310) on which an electrical wire (such as conductive wire 1320) unwinds and winds is used. The electrical wire spool is rotatably mounted on a shaft rotated by the motor, such as the electrical wire spool 1310 and biasing arrangement described above and shown in FIG. 13. The electrical wire spool is connected to the gripping assembly. Sensor 1630 comprises sensor 1300. Upon the gripping assembly being obstructed, the electrical wire spool 1310 of FIG. 13 will return to its biased state. That is, the electrical wire spool 1310 will no longer experience a pull due to the movement of the container-lifting assembly and snap back to its biased state. The return to the bias state will mean the output of sensor 1300 in this implementation will no longer correlate to the output provided by sensor 1620, and an obstruction will be detected as explained above. Additionally, or alternatively, the vertical position of the gripper assembly can be derived from sensor 1630 in this implementation and compared with the input provided by 1640 to determine an obstruction.

In another implementation of the method of FIG. 17, sensor 1630 comprises a ToF sensor such as that described above and shown in FIG. 14 (ToF sensor 1410, or in general, any laser sensor that measures distance can be used.). Upon the gripping assembly being obstructed, the ToF sensor will no longer detect a change in distance. Alternatively, the gripper assembly can tilt to the extent that the ToF sensor will no longer detect a return optical signal due to losing alignment with the reflective surface. The non-changing distance measurement or lack of a return optical signal will mean the output of sensor 1630 in this implementation will no longer correlate to the output provided by sensor 1620, and an obstruction will be detected as explained above. Additionally, or alternatively, the vertical position of the gripper assembly can be derived from sensor 1630 in this implementation and compared with the input provided by 1640 to determine an obstruction.

In one implementation of the method of FIG. 17, an electrical cable spool (such as FFC spool 840/940) on which an electrical cable (such as FFC 830) unwinds and winds is used. The electrical cable spool is rotatably mounted on a shaft rotated by the motor, such as the FFC spool 940 and biasing arrangement described above and shown in FIG. 9. The electrical cable spool is connected to the gripping assembly and electrically communicates therewith. Sensor 1630 comprises an electrical cable spool sensor comprising a light source and a light detector, such as that described above and shown in FIG. 15. As explained above, a light source is configured to transmit an optical signal onto a surface that moves as the gripping assembly is raised and/or lowered. The light detector is configured to detect a reflection of the optical signal from the surface to detect movement of the surface. The raising and lowering assembly comprises a wheel that is in contact with the electrical cable spool on which electrical cable winds and/or unwinds, wherein the wheel comprises the surface, or alternatively the electrical cable spool comprises the surface. Upon the gripping assembly being obstructed, the FFC spool 940 of FIG. 9 will return to its biased state. That is, FFC spool and FFC will no longer experience a pull due to the movement of the container-lifting assembly and snap back to its biased state. The return to the bias state will mean the rotary encoder output of sensor 1630 in this implementation will no longer correlate to the output provided by sensor 1620, and an obstruction will be detected as explained above. Additionally, or alternatively, the vertical position of the gripper assembly can be derived from sensor 1630 in this implementation and compared with the input provided by 1640 to determine an obstruction.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention can take the form of an entirely hardware embodiment, an entirely software embodiment or an embodiment containing both hardware and software elements. In a preferred embodiment, the invention is implemented in software.

Furthermore, the invention can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present invention. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

1. A lifting assembly for raising and/or lowering a container from and/or to a stack of a plurality of containers in a grid storage structure, the lifting assembly comprising:
a gripping assembly configured to grip a load;
a raising and lowering assembly configured to raise and lower the gripping assembly, the raising and lowering assembly comprising:
at least one tether connected to the gripping assembly; and
a motor to wind and/or unwind the at least one tether to raise and/or lower the gripping assembly;
a sensor configured to detect movement of the gripping assembly, wherein the sensor comprises an input that is engaged by movement of the gripping assembly;
a controller configured to determine a vertical position of the gripping assembly using an output of the sensor; and
an electrical cable connected to the gripping assembly, wherein the electrical cable is configured to wind and/or unwind as the gripping assembly is raised and/or lowered,
wherein the sensor is configured to detect an extent to which the electrical cable has wound and/or unwound.

2. The lifting assembly of claim 1, further comprising an electrical cable spool on which the electrical cable winds and/or unwinds, wherein the sensor comprises a rotary encoder configured to engage with the electrical cable spool to detect an extent to which the electrical cable spool has rotated as the electrical cable winds and/or unwinds.

3. The lifting assembly of claim 1, wherein the electrical cable has a higher modulus of elasticity than the at least one tether.

4. The lifting assembly of claim 2, further comprising at least one tether spool for the at least one tether on which the at least one tether winds and/or unwinds, wherein the electrical cable spool and the at least one tether spool are mounted on a shaft such that the electrical cable spool can rotate relative to the at least one tether spool.

5. The lifting assembly of claim 2, further comprising a biasing assembly configured to oppose winding or unwinding of the electrical cable spool such that the electrical cable is taut between the raising and lowering assembly and the gripping assembly.

6. The lifting assembly of claim 1, wherein the electrical cable communicates electrical signals to the gripping assembly.

7. The lifting assembly of claim 1, wherein the electrical cable comprises fixed flexible cable (FFC) or ribbon cable.

8. The lifting assembly of claim 1, wherein the controller is configured to use the vertical position of the gripping assembly to control or adjust raising or lowering of the gripping assembly.

9. The lifting assembly of claim 1, wherein the at least one tether comprises four tethers.

10. The lifting assembly of claim 1, wherein the at least one tether comprises steel tape or woven polyester tape.

11. A load-handling device for lifting and moving a plurality of storage containers stacked in a grid framework structure, the grid framework structure comprising a first set of parallel rails or tracks and a second set of parallel rails or tracks, the second set of parallel rails or tracks extending substantially perpendicularly to the first set of rails or tracks in a substantially horizontal plane to form a grid pattern comprising a plurality of grid spaces, wherein:
the grid framework structure is supported by a set of uprights to form a plurality of vertical storage locations beneath the grid framework structure for the plurality of storage containers to be stacked between and guided by the set of uprights in a vertical direction through the plurality of grid spaces, and
the load-handling device comprises:
a body or skeleton mounted on a first set of wheels and a second set of wheels, the first set of wheels configured to engage with the first set of parallel tracks and the second set of wheels configured to engage with the second set of parallel tracks; and
a container-lifting assembly comprising the lifting assembly of claim 1, wherein the gripping assembly comprises a container-gripping assembly configured to grip a container.

12. A method for determining the vertical position for the gripping assembly of the lifting assembly of claim 1, wherein the method comprises:
using the motor to raise and/or lower the gripping assembly;
using the controller to determine a vertical position of the gripping assembly using the output of the sensor.
